(19) United States
(12) Patent Application Publication
(10) Pub. No.: US 2019/0064027 A1
(43) Pub. Date: Feb. 28, 2019

(54) DETERMINING VEHICLE WHEEL IMBALANCE

(71) Applicant: Ford Global Technologies, LLC, Dearborn, MI (US)

(72) Inventors: Thomas G. Leone, Ypsilanti, MI (US); Kenneth James Miller, Canton, MI (US)

(73) Assignee: Ford Global Technologies, LLC, Dearborn, MI (US)

(21) Appl. No.: 15/691,317

(22) Filed: Aug. 30, 2017

(51) Int. Cl. G01M 1/28; G07C 5/02

(52) U.S. Cl. CPC G01M 1/28; G07C 5/008; G07C 5/02

(57) ABSTRACT

A vehicle computer is described that includes a processor and memory storing instructions executable by the processor. The instructions may include, to: determine a vehicle speed; determine, for a first wheel, a first vibration profile; determine, for a second wheel, a second vibration profile that includes a roadway disturbance input; and using the speed and the two profiles, determine a wheel imbalance at the first wheel.

### BACKGROUND

Unbalanced vehicle wheels can result in abnormal or excessive tire wear. This may require an owner of the vehicle to replace vehicle tires before a prescribed tire life. In some instances, an unbalanced wheel can reduce vehicle traction.

### BRIEF DESCRIPTION OF THE DRAWINGS

FIG. 1 is schematic diagram of a wheel imbalance sensing system that includes a vehicle operable in a fully autonomous mode and an onboard computer.

FIG. 2 a perspective view of the vehicle of FIG. 1.

FIG. 3 is another schematic diagram of the vehicle shown in FIG. 1, illustrating alternative locations of some of the sensors of the system.

FIGS. 4-6 are graphical depictions of exemplary sensor data receivable by the system.

FIGS. 7-8 are flow diagrams illustrating an exemplary process which may be executed by the system.

### DETAILED DESCRIPTION

A wheel imbalance sensing system is described that includes a vehicle computer. According to one illustrative example, the computer may execute a method that includes: determining a vehicle speed; determining, for a first wheel, a first vibration profile; determining, for a second wheel, a second vibration profile that includes a roadway disturbance input; and using the speed and the two profiles, determining a wheel imbalance at the first wheel.

According to the at least one example set forth above, the method further may include, at the computer: using a wheelbase distance to determine the imbalance.

According to the at least one example set forth above, the first and second wheels are on a common side of a vehicle.

According to the at least one example set forth above, determining the imbalance comprises determining an absence of correlation between a vibration magnitude in the first vibration profile and the input of the second vibration profile.

According to the at least one example set forth above, determining the imbalance further comprises: determining a vibration profile for each of a plurality of wheels in the vehicle; and determining that the vibration magnitude of one profile is a threshold larger than vibration magnitudes associated with a remainder of the plurality.

According to the at least one example set forth above, the first and second vibration profiles comprise acceleration data.

According to the at least one example set forth above, the acceleration data is provided to the computer via one or more accelerometers located at each of the first and second wheels.

According to the at least one example set forth above, the first and second vibration profiles further comprise rotational-rate data.

According to the at least one example set forth above, the rotational-rate data is provided to the computer via one or more rotational-rate sensors which comprise one of an antilock brake system, an electronic stability control system, or a roll stability control system.

According to the at least one example set forth above, the method further may include: distinguishing debris captured within a tire tread from wheel imbalance.

According to another illustrative example, a method that includes, for a vehicle: determining, for a first wheel, a first vibration profile; determining, for a second wheel, a second vibration profile that includes a roadway disturbance input; attempting to correlate the first and second profiles; and based on an absence of correlation, determining a wheel imbalance at the first wheel.

According to the at least one example set forth above, the method further may include: performing at least a portion of the wheel imbalance determination at a remote server.

According to another illustrative example, a computer may include a processor and memory storing instructions executable by the processor. The instructions may include, to: determine a vehicle speed; determine, for a first wheel, a first vibration profile; determine, for a second wheel, a second vibration profile that includes a roadway disturbance input; and using the speed and the two profiles, determine a wheel imbalance at the first wheel.

According to the at least one example set forth above, the instructions further may include, to: use a wheelbase distance to determine the imbalance.

According to the at least one example set forth above, the first and second wheels are on a common side of a vehicle.

According to the at least one example set forth above, the instructions to determine the imbalance further include, to: determine an absence of correlation between a vibration magnitude in the first vibration profile and the input of the second vibration profile.

According to the at least one example set forth above, the instructions to determine the imbalance further include, to: determine a vibration profile for each of a plurality of wheels in the vehicle; and determine that the vibration magnitude of one profile is a threshold larger than vibration magnitudes associated with a remainder of the plurality.

According to the at least one example set forth above, the first and second vibration profiles comprise acceleration data.

According to the at least one example set forth above, the acceleration data is provided to the computer via one or more accelerometers located at each of the first and second wheels.

According to the at least one example set forth above, the first and second vibration profiles further comprise rotational-rate data.

According to the at least one example, a computer is disclosed that is programmed to execute any combination of the examples set forth above.

According to the at least one example, a computer is disclosed that is programmed to execute any combination of the examples of the method(s) set forth above.

According to the at least one example, a computer program product is disclosed that includes a computer readable medium storing instructions executable by a computer processor, wherein the instructions include any combination of the instruction examples set forth above.

According to the at least one example, a computer program product is disclosed that includes a computer readable medium that stores instructions executable by a computer processor, wherein the instructions include any combination of the examples of the method(s) set forth above.

Now turning to the figures, wherein like numerals indicate like parts throughout the several views, there is shown a wheel imbalance sensing system 10 that may include a backend server 12 and an autonomous vehicle 14 comprising an onboard sensing system 16 that includes a computer 18 that is programmed to: determine whether sensor data (e.g., such as acceleration, rotational-rate, and/or wheel speed data) is available from sensors used by vehicle motion sensing systems (e.g., such an antilock braking system, an electronic stability control system, a roll stability control system, or the like); when it is available, at computer 18, receive and analyze the sensor data to determine a wheel imbalance; identify which wheel is unbalanced; and then in response to determining the wheel imbalance, execute a vehicle function such as generating a diagnostic trouble code (DTC) or report indicating a need for vehicle service. In some examples, at least some computer-implemented instructions discussed herein may be executed by the backend server 12, as will be explained more below.

The onboard system 16 may be particularly suitable for autonomous vehicles. For example, trained drivers or service technicians may be capable of diagnosing wheel imbalance by touch or feel during a test drive—e.g., based on touch response over smooth roadway, response to steering inputs, or the like. However, autonomous vehicles such as vehicle 14—which are driven by computer 18 and which do not have a human driver—may be unable to drive by such human-feel. Furthermore, while passengers, during transport, may feel vehicle vibration caused by an unbalanced wheel, many passengers may not be motivated to report the experience (e.g., especially when the vehicle 14 is an autonomous taxi or the like and the passenger only uses the vehicle 14 for a single trip).

As discussed above, in at least one example, wheel imbalance sensing system 10 may comprise backend server 12 which can be used to perform calculations, execute time- and/or processing-intensive algorithms, etc.; however, server 12 is not required in all examples. Server 12 may comprise one or more computing devices 20 which may be interconnected via a wired or wireless interface (e.g., one computing device 20 is shown for illustrative purposes). The computing device 20 may be programmed to execute at least some of the same instructions that computer 18 is programmed to execute. For example, computing device 20 may be programmed to receive sensor data from vehicle 14 (e.g., wirelessly) and analyze that data to determine whether a wheel is unbalanced and/or to determine which wheel is experiencing unbalance greater than a threshold. For example, computing device(s) 20 may perform these calculations to expedite computer processing time and/or to conserve computer-processing resources at the vehicle 14. As will be explained more below, when the server 12 provides an imbalance determination to vehicle 14, computer 18 may take appropriate corrective action.

Computing device 20 may comprise one or more processors 22 coupled to memory 24. For example, processor 22 can be any type of device capable of processing electronic instructions—non-limiting examples including a microprocessor, a microcontroller or controller, an application specific integrated circuit (ASIC), etc.—just to name a few. In general, processor(s) 22 may be programmed to execute digitally-stored instructions, which may be stored in memory 24, which enable the computing device 20, among other things, to determine wheel imbalance.

Memory 24 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 24 may store one or more computer program products which may be embodied as software, firmware, or the like.

According to at least one example, server 12 may comprise one or more databases 26 as well—e.g., coupled to processor(s) 22. Database(s) 26 may store one more vehicle data records in a centralized repository. Data records may store information pertaining to the particular vehicle 14, user of the vehicle 14, etc. A non-limiting example of a data record may include a data array that comprises: a year of manufacture of vehicle 14, a make of vehicle 14, a model of vehicle 14, a vehicle identification number (VIN) of vehicle 14, one or more features and accessories of vehicle 14 (e.g., manufacturer package, extras, etc.), environmental data relative to the vehicle 14 (e.g., state or city of the user), driving habits of the user(s) of vehicle 14, diagnostic data of the vehicle 14, tire pressure data at each tire of wheels 28FL, 28FR, 28RL, 28RR of vehicle 14, authorized service data, and the like. Server 12 may utilize sensor data received from vehicles 14, imbalance notifications received from vehicles 14, as well as the data record information to determine patterns which may assist a manufacturer in addressing wheel imbalance issues before they arise. Furthermore, at least some of sensor data may be used by server 12 in predictive algorithms—e.g., particularly in vehicles 14 having common make, model, suspension systems, chassis, etc.

Server 12 may have a wireless transceiver 29 or be coupled to such a transceiver, enabling server 12 to be in communication with vehicle 14 (and other similarly-equipped vehicles) via a wired and/or wireless communication network 30, which communication network may comprise a land communication network, a wireless communication network, or a combination thereof, as will be appreciated by those skilled in the art. For example, a land communication network can enable connectivity to public switched telephone network (PSTN) such as that used to provide hardwired telephony, packet-switched data communications, internet infrastructure, and the like. And a wireless communication network may include satellite communication architecture and/or may include cellular telephone communication over wide geographic region(s). Thus, in at least one example, network 30 includes any suitable cellular infrastructure that could include eNodeBs, serving gateways, base station transceivers, and the like. Further, network 30 may utilize any suitable existing or future cellular technology (e.g., including LTE, CDMA, GSM, etc.).

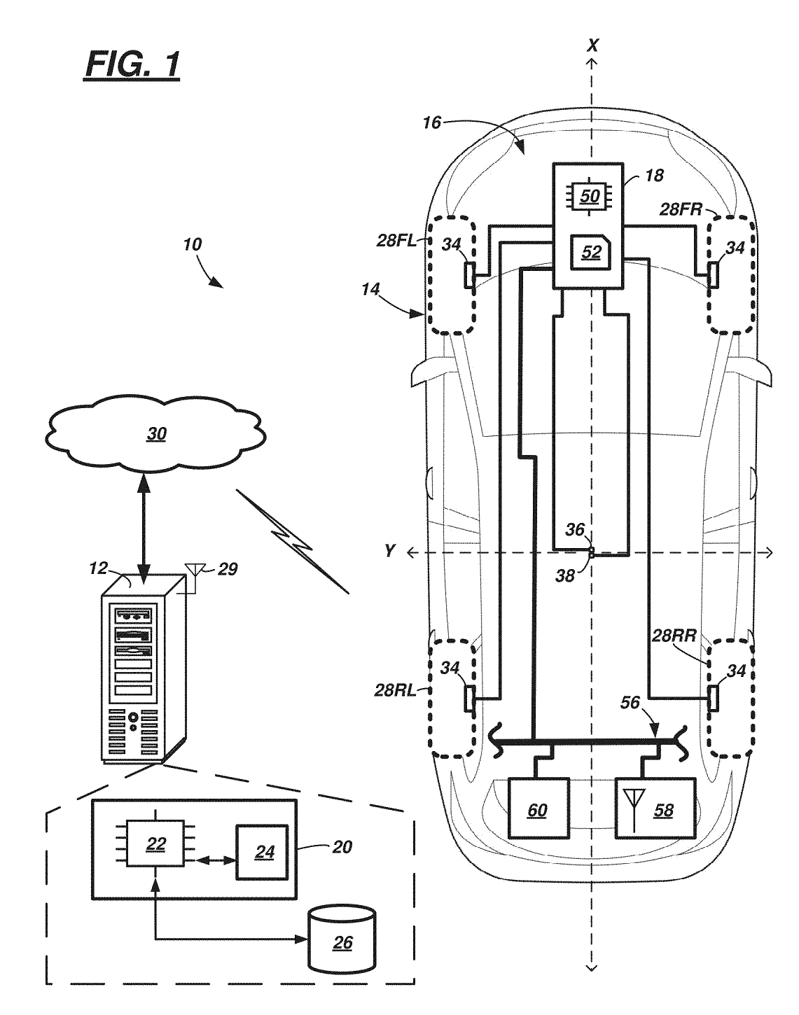

Turning now to the vehicle shown in FIGS. 1-3, vehicle 14 is shown as a passenger car; however, vehicle 14 could also be a truck, sports utility vehicle (SUV), recreational vehicle, bus, or the like that includes the onboard sensing system 16. Vehicle 14 may be operated in any one of a number of autonomous modes. In at least one example, vehicle 14 may operate as an autonomous taxi or the like—e.g., operating in a fully autonomous mode (e.g., a level 5), as defined by the Society of Automotive Engineers (SAE) (which has defined operation at levels 0-5). For example, at levels 0-2, a human driver monitors or controls the majority of the driving tasks, often with no help from the vehicle 14. For example, at level 0 (“no automation”), a human driver is responsible for all vehicle operations. At level 1 (“driver assistance”), the vehicle 14 sometimes assists with steering, acceleration, or braking, but the driver is still responsible for the vast majority of the vehicle control. At level 2 (“partial automation”), the vehicle 14 can control steering, acceleration, and braking under certain circumstances without human interaction. At levels 3-5, the vehicle 14 assumes more driving-related tasks. At level 3 (“conditional automation”), the vehicle 14 can handle steering, acceleration, and braking under certain circumstances, as well as monitoring of the driving environment. Level 3 may require the driver to intervene occasionally, however. At level 4 (“high automation”), the vehicle 14 can handle the same tasks as at level 3 but without relying on the driver to intervene in certain driving modes. As used herein, a fully autonomous vehicle such as vehicle 14 is one operable at level 5 (“full automation” or in a “fully autonomous mode”), wherein the vehicle 14 (or more particularly, one or more onboard fully autonomous computers) can handle all driving tasks without any driver intervention. And, according to one example, it is in a fully autonomous mode that the present disclosure may assist users (e.g., such as a driver, passenger, or maintenance personnel) with information regarding wheel imbalance—e.g., as such a user may not touch a steering wheel or otherwise feel wheel imbalance (as in some conventional manners).

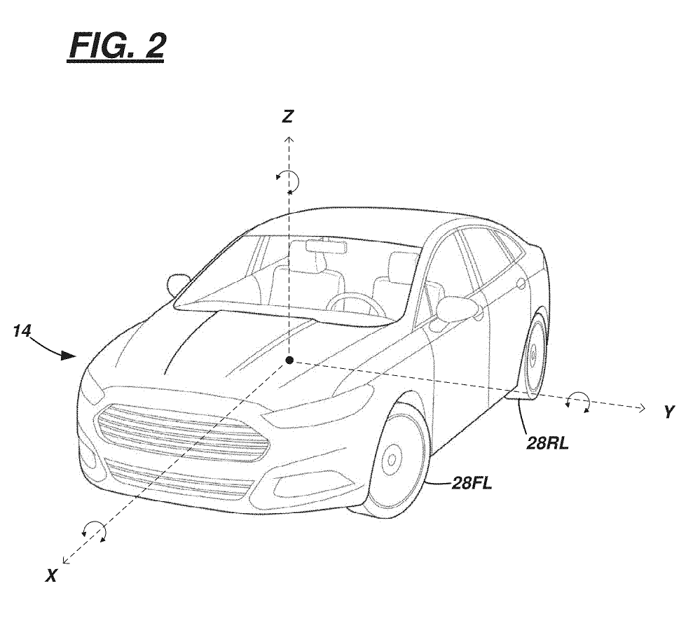

Onboard sensing system 16 may be configured to provide sensor data from a plurality of sensors 34, 36, 38 to computer 18 which determines wheel imbalances. Non-limiting examples of these sensors include: one or more wheel speed sensors 34, one or more acceleration sensors 36 (e.g., x-, y-, and/or z-axis sensors—e.g., positioned with respect to the X-, Y-, and Z-axes of vehicle 14, as exemplified in FIG. 2), and one or more vehicle rotational-rate sensors 38 (e.g., roll, yaw, and/or pitch sensors). In some examples, other types of vehicle sensors (e.g., such as suspension system sensors or imaging system sensors) may be used in addition to at least some of those described herein.

Some aspects of computer 18 may be similar to the computing device 20 of server 12. For instance, according to one example, computer 18 is programmed to make at least some of the same wheel imbalance determinations as server 12, including calculating or otherwise determining a wheel imbalance greater than a threshold. According to another example, computer 18 is programmed to upload sensor data to the server 12, permit the server 12 to make wheel imbalance determinations, and then receive in return an imbalance determination which may trigger the computer 18 to execute one or more vehicle driving functions.

Computer 18 may be a single computer (or multiple computing devices—e.g., shared with other vehicle systems and/or subsystems). In at least one example, computer 18 is or is part of an anti-lock braking system (ABS) module, roll stability control (RSC) module, an electronic stability control (ESC) module, a combination thereof, or the like. However, it should be appreciated that these are merely examples; e.g., in other instances, computer 18 may be a dedicated system apart from these or other existing vehicles computers. Computer 18 may comprise a processor 50 coupled to memory 52. For example, processor 50 can be any type of device capable of processing electronic instructions, non-limiting examples including a microprocessor, a microcontroller or controller, an application specific integrated circuit (ASIC), etc.—just to name a few. In general, computer 18 may be programmed to execute digitally-stored instructions, which may be stored in memory 52, which enable the computer 18, among other things, to determine wheel imbalance in the vehicle 14 and determine which wheel 28FL, 28FR, 28RL, 28RR is experiencing the imbalance.

Memory 52 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 52 may store one or more computer program products which may be embodied as software, firmware, or the like.

As discussed above, vehicle 14 may comprise one or wheel speed sensors 34; e.g., in the illustrations, each wheel 28FL, 28FR, 28RL, 28RR comprises at least one sensor; however, this is not required. For example, in some implementations, only one wheel comprises a wheel speed sensor 34. The wheel speed sensor 34 may measure and/or calculate angular wheel speed at the respective wheel.

Acceleration sensors 36 (e.g., x-, y-, and/or z-axis sensors) may be any suitable sensor for detecting an acceleration in the vehicle's X-, Y-, and/or Z-axis. According to one example, sensor 36 may be a single tri-axis accelerometer positioned and oriented in the vehicle 14 in order to measure accelerations in the X-, Y-, and Z-axes. In another example, a separate accelerometer may be used for each of the X-, Y-, and/or Z-axes—e.g., and each of these single-axis accelerometers may be located on or relative to a respective X-, Y-, and Z-axis. Sensor(s) 36 may be part of the anti-lock braking system (ABS) module, the roll stability control (RSC) module, the electronic stability control (ESC) module, or the like; further, the ABS, RSC, and/or ESC systems may have priority with respect to receiving sensor data. Thus, in at least some examples, computer 18 may not responsively receive sensor data—e.g., if these or other suitable vehicle systems require it first. For example, autonomous braking controls, roll stability actions, lane stability actions, etc. may take priority over computer 18 determining whether a wheel is unbalanced.

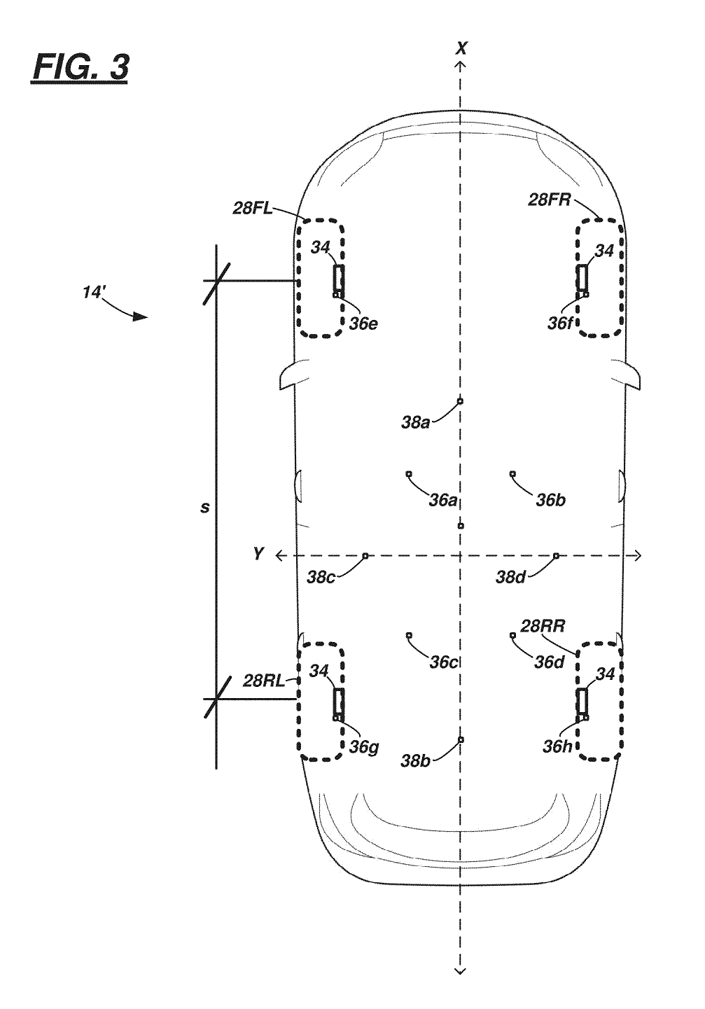

According to at least some examples, sensors 36 and 38 may be arranged differently. For example, FIG. 3 illustrates that a vehicle 14′ may comprise multiple acceleration sensors. In the illustration, four exemplary tri-axis accelerometers 36a, 36b, 36c, and 36d are shown within the body of vehicle 14′—e.g., not located necessarily at a respective wheel. Further, in one example, each wheel 28FL, 28FR, 28RL, 28RR could have a corresponding acceleration sensor 36e, 36f, 36g, 36h (respectively). This is merely one example. The quantity and distribution of the sensors in the vehicle may vary; and other quantities and/or distributions may be implemented instead.

Returning to FIG. 2, rotational-rate sensors 38 (e.g., roll, yaw, and/or pitch sensors) may include any suitable sensor for detecting rotational movement of the vehicle 14 about the X-, Y-, and/or Z-axes. One non-limiting example of a rotational-rate sensor 38 is a gyroscope. Again, a tri-axis gyroscope could be used, or several single-axis gyroscopes may be used. In at least one example, vehicle 14 comprises at least a rotational-rate sensor 38 that measures and/or calculates yaw or pitch of vehicle 14. Similar to that discussed above, sensor(s) 38 may be part of the anti-lock braking system (ABS) module, the roll stability control (RSC) module, the electronic stability control (ESC) module, or the like; further (as discussed above), the ABS, RSC, and/or ESC systems may have priority over computer 18 with respect to receiving sensor data.

According to at least one example, vehicle 14′ (FIG. 3) may comprise multiple rotational-rate sensors for measuring rotations about the X-, Y-, and/or Z-axes—e.g., four exemplary tri-axis rotational-rate sensors 38a, 38b, 38c, and 38d are shown. Again, the quantity and distribution of the sensors 38a-38d are merely an example; other quantities and/or distributions may be implemented instead.

In at least some examples (as shown in FIG. 1), vehicle 14 may comprise a wired or wireless network connection 56 which communicatively couples computer 18 to a telematics device 58—e.g., enabling computer 18 to communicate with server 12 via telematics device 58 and communication network 30. Non-limiting examples of network connection 56 include one or more of a controller area network (CAN) bus, Ethernet, Local Interconnect Network (LIN), a fiber optic connection, or the like. Other examples also exist. For example, alternatively or in combination with e.g., a CAN bus, connection 56 could comprise one or more discrete wired or wireless connections.

Telematics device 58 may be any suitable telematics computing device configured to wirelessly communicate with other electronic devices. Such wireless communication may include use of cellular technology (e.g., LTE, GSM, CDMA, and/or other cellular communication protocols), short range wireless communication technology (e.g., using Wi-Fi, Bluetooth, Bluetooth Low Energy (BLE), dedicated short range communication (DSRC), and/or other short range wireless communication protocols), or a combination thereof. Such communication includes so-called vehicle-to-vehicle (V2V) and vehicle-to-infrastructure (V2I) communications as well—all of which will be appreciated by those skilled in the art.

In at least one example, vehicle 14 further comprises a human-machine interface (HMI) module 60. HMI module 60 may include any suitable input and/or output devices such as switches, knobs, controls, etc.—e.g., on an instrument panel, steering wheel, etc. of vehicle 14—which are coupled communicatively to computer 18 (e.g., also via network connection 56). In one non-limiting example, HMI module 60 may comprise an interactive touch screen or display which provides alert or notification information to the users of vehicle 14. For example, the alert or notification may be addressed to a user of the vehicle 14 to direct the vehicle to an authorized vehicle service center or dealership to repair an unbalanced wheel.

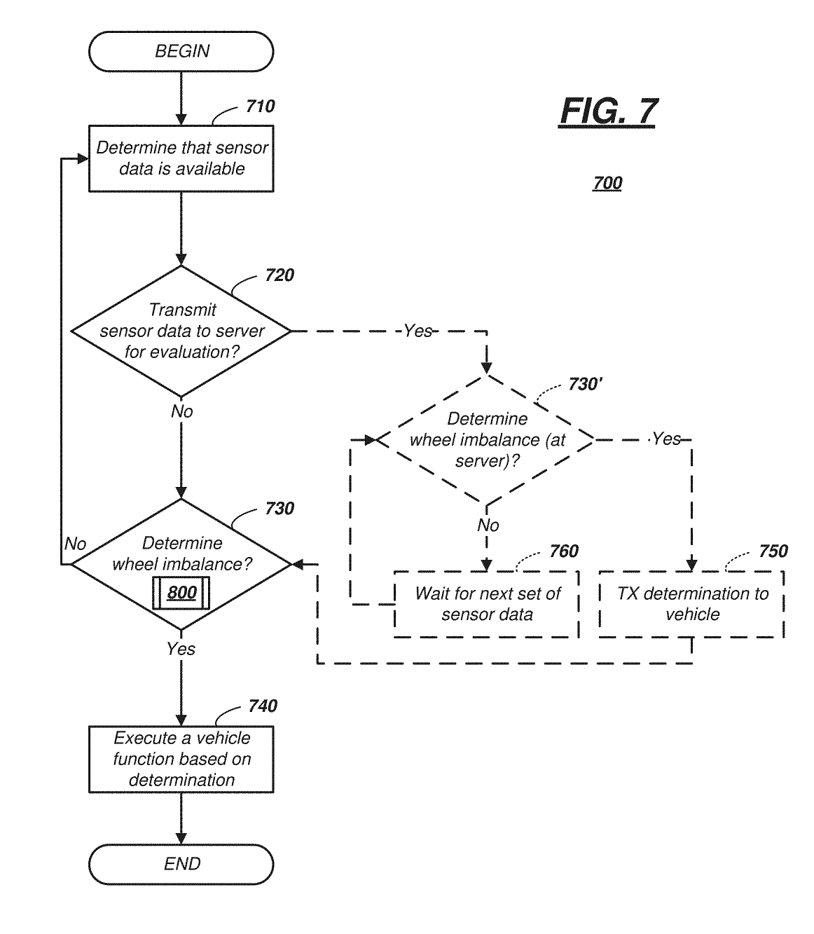

Turning now to FIG. 7, a process 700 (executable at least in part by computer 18) is illustrated that includes determining an existence of wheel imbalance at one of the wheels of vehicle 14. As explained below, if a wheel imbalance is determined, then computer 18 executes at least one vehicle driving function. The process begins with block 710 which includes computer 18 determining that sensor data is available (e.g., from one or more of sensors 34-38). As discussed above, this instruction may be executed because a signal carrying sensor data from sensors 34-38 may not always be readily available to computer 18 without disrupting other processes in vehicle 14 (e.g., processes pertaining to anti-lock braking, roll stability control, electronic stability control, etc.). In some examples, block 710 is executed during periods of low-use or no-use by other vehicle systems. Regardless, when computer 18 determines that the signal(s) are available, process 700 proceeds to block 720.

In block 720, computer 18 may determine whether to transmit the sensor data to server 12 so that the server may evaluate whether wheel imbalance exists at vehicle 14 or whether to make this determination at the vehicle 14. According to one example, computer 18 may package a digital file of sensor data (received from one or more of sensors 34-38) and transmit it to server 12 via telematics device 58. In this manner, computer 18 may permit the server 12 to perform one or more time-intensive computer-processing computations and determinations, thereby reserving the computing resources of computer 18 for other operations. When in block 720 computer 18 determines to transmit the sensor data to server 12, then process 700 proceeds to block 730′. And when in block 720 computer 18 determines to not export the sensor data to server 12, then process 700 proceeds from block 720 to block 730.

In block 730, computer 18 uses the sensor data to determine whether at least one of the wheels is experiencing wheel imbalance greater than a threshold. In at least one example, computer 18 determines whether a wheel imbalance exists using sensor data from one or more wheel speed sensor(s) 34, one or more acceleration sensors 36, and/or one or more rotational-rate sensor(s) 38. In another instance, computer 18 utilizes sensor data from each of sensors 34-38; and in other instances, other combinations of sensor data from at least some of sensors 34-38 is used.

According to one non-limiting example, while vehicle 14 is moving, computer 18 determines whether a wheel imbalance exists using sensor data from at least one wheel speed sensor 34 and at least one acceleration sensor 36. According to some examples, sensor data is used to determine a probability of wheel imbalance. For example, a greater probability may exist when multiple acceleration sensors 36 indicate an imbalance (or when one or more acceleration sensors 36 indicate an imbalance, as do one or more rotational-rate sensors 38).

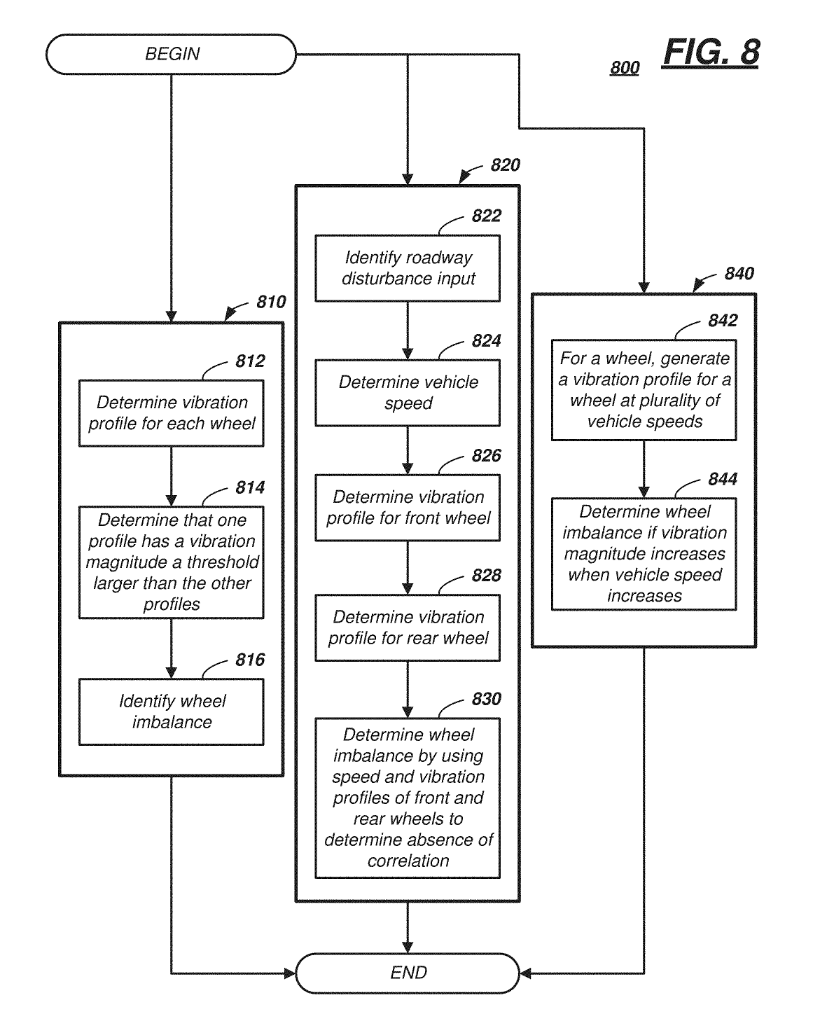

Block 730 may comprise one or more subroutines executable by computer 18 which may be used to determine a wheel imbalance. A few subroutine examples are illustrated in FIG. 8 (illustrating a process 800).

More particularly, FIG. 8 illustrates subroutines 810, 820, 840. These subroutines may be executed individually and/or collectively. For example, each executed subroutine 810, 820, 840 which results in a determination that a vehicle wheel is likely to be unbalanced may increase an overall likelihood that computer 18 accurately determines a wheel imbalance. Thus, subroutines 810, 820, 840 may be executed by computer 18 singly, or in combination with one another. Further, they be executed in any desirable order. In at least one example, subroutine 810 is executed prior to subroutines 820 or 830; however, this is merely illustrative.

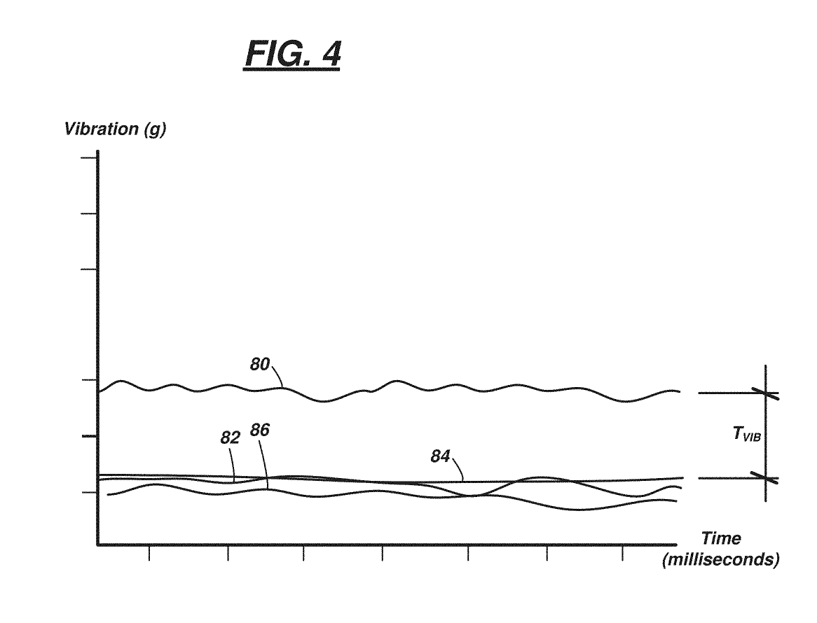

Subroutine 810 may comprise instructional blocks 812, 814, and 816. In block 812, computer 18 may determine a vibration profile for each wheel 28FL, 28FR, 28RL, 28RR. FIG. 4 provides a graphical depiction of four vibration profiles 80, 82, 84, 86—which correspond to sensor measurements at wheels 28FL, 28FR, 28RL, and 28RR, respectively. For example, FIG. 4 shows an independent axis (e.g., time in milliseconds) and a dependent axis (e.g., a vibration magnitude (in G or kg*m/ŝ2). Thus, the illustrated profiles 80-86 may be mathematical functions of vibration magnitude with respect to unit time. It should be appreciated that acceleration sensor data is shown for purposes of illustration only and not to be limiting (e.g., rotational-rate data could be used in addition to or instead). Further, the illustrated sensor data is for explanatory purposes (and not is test data or empirical data).

Continuing with the subroutine example, computer 18 (in block 814) may determine that one profile may have a vibration magnitude a threshold larger than the other profiles. For example, profile 80 (associated with a left front wheel 28FL of vehicle 12) is shown having a relatively constant vibration magnitude larger than profiles 82-86 (of wheels 28FR, 28RL, 28RR). In this example, an average vibration magnitude of profile 80 (e.g., over a predetermined time interval) is larger than an average vibration magnitude of profiles 82-86, collectively or individually. Further, in at least the illustrated example, an average vibration magnitude of profile 80 (e.g., over a predetermined time interval) is a threshold (T_{VIB}) larger than an average vibration magnitude of the largest of any of profiles 82-86 (e.g., profile 80 is a threshold (T_{VIB}) larger than the next largest vibration profile 84 or that of the rear left wheel 28RL). Other techniques for determining whether a vibration magnitude of one profile is larger than other profiles are also possible.

In block 816 which follows, computer 18 may determine that a wheel associated with the larger profile is unbalanced. For instance, in the illustrated example of FIG. 4, computer 18 may determine that wheel 28FL is experiencing wheel imbalance. According to one example, computer 18 identifies the particular wheel based on a proximity of acceleration sensors 36. For example, when the profile 80 is determined using one or more sensors located at the respective wheel 28FL (e.g., such as sensor 36e), then computer 18 may use this location information to determine that wheel 28FL is unbalanced. In some examples, acceleration sensors may not be located at the wheels 28FL, 28FR, 28RL, 28RR (e.g., no sensors 36e-36h). In these instances, computer 18 may determine or identify the wheel using triangulation or multilateration (MLAT) techniques. For example, computer 18 may use sensors 36a-36d instead. According to one MLAT technique, the vibratory sensor data at sensor 36a may be largest when wheel 28FL is unbalanced. Further, vibratory sensor data received at sensors 36b and 36c may be greater than vibratory sensor data received from sensor 36d (but not as large as that received at sensor 36a). Of course, this example pertains to a wheel imbalance at wheel 28FL. Magnitudes of vibratory sensor data may be larger at other sensors when one of respective wheels 28FR, 28RL, 28RR is unbalanced.

Thus, subroutine 810 may be used to not only determine a wheel imbalance, but also to identify which wheel on vehicle 14 (14′) is unbalanced more than a threshold. As discussed above, subroutines 820 and/or 840 may be executed with subroutine 810 (e.g., sequentially or at least partially concurrently).

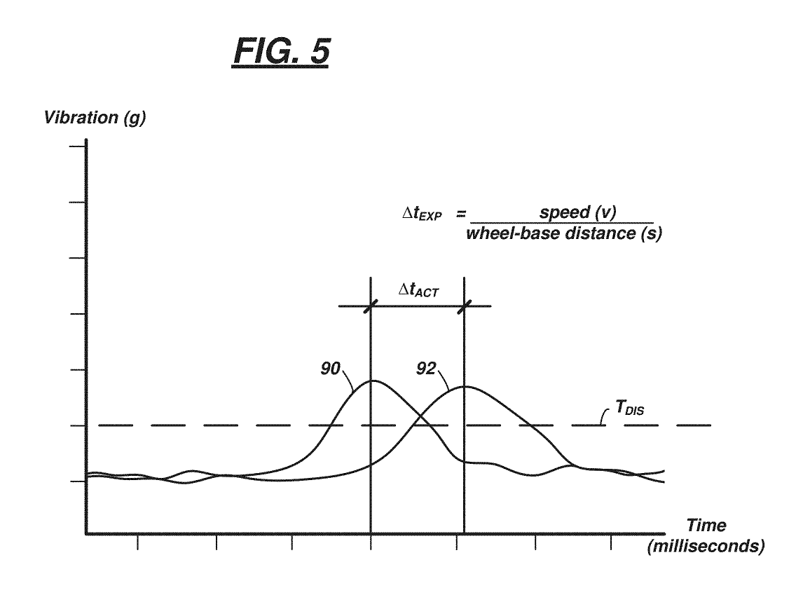

Subroutine 820 may comprise instructional blocks 822, 824, 826, 828, and 830. In block 822, computer 18 may determine or identify a roadway disturbance input to vehicle 14. As used herein, a roadway disturbance input is electrical signal data received via one or more vehicle sensors which indicate that at least one of the vehicle wheels 28FL, 28FR, 28RL, 28RR has passed over or through a protrusion in a roadway, a depression in a roadway, or an obstruction on the roadway thereby causing a mechanical impulse (or series of impulses) to at least one of the vehicle wheels, wherein vehicle sensor(s) (e.g., such as sensors 36, 38) may convert that mechanical impulse (or series of impulses) into an electrical signal. Thus, the roadway disturbance input may be momentary (e.g., a result of a so-called bump in the road or repetitive bumps such as a so-called wash-boarded or pot-holed roadway). According to one example, the disturbance input may result in a vibration being greater than a predetermined threshold (T_{DIS}), as shown in FIG. 5.

In block 824, computer 18 may determine a speed (v) of the vehicle 14 (e.g., at the time of the roadway disturbance input). According to one example, computer 18 determines an angular speed of the respective wheel (using at least one of the wheel speed sensors 34), and based on that angular speed, determines an instantaneous speed of the vehicle at the time of the input. Of course, vehicle speed v may be determined in other ways as well, including determining an average speed over a relatively short interval or the like.

In block 826, computer 18 determines a vibration profile for one of the wheels, and in block 828, computer 18 determines a vibration profile for another one of the wheels. In at least one example, determining which two vibration profiles to select is based on which of wheels 28FL, 28FR, 28RL, 28RR received the roadway disturbance input (or e.g., which two vibration profiles received the relatively larger roadway disturbance inputs). In many instances, these two profiles will be a front wheel on one side of the vehicle 14 and a corresponding rear wheel on the same or common side (e.g., either the port side wheels 28FL, 28RL or the starboard side wheels 28FR, 28RR); however, this is merely an example, and other combinations are possible. For purposes of illustration only, the description herein of subroutine 820 will use the port side wheels 28FL and 28RL. Thus, continuing with the present example, in block 826, computer 18 determines or generates a vibration profile 90 for wheel 28FL, and in block 828, computer 18 determines or generates a vibration profile 92 for wheel 28RL (see also FIG. 5).

According to at least one example, computer 18 may filter the sensor data (e.g., from acceleration sensor(s) 36 and/or rotational-rate sensors 38) according to the angular frequency of the wheels 28FL, 28RL. The vibratory sensor data may manifest itself as undesirable noise at the angular frequency of the respective wheel. Thus, for purposes of illustration only, if the wheel is rotating 750 revolutions per minute (rpm), then computer 18 may create a notch filter around 45 kiloHertz (kHz). Further, memory 52 may store wheel rim diameter, tire body size, etc.; thus, based on angular velocity, computer 18 may be programmed to calculate vehicle speed v (e.g., which may be approximately 60 mph when the wheel rotates at 750 rpm). Again, these numbers are used for illustration purposes only and are not intended to be limiting. Thus, using a filter, computer 18 may be able to generate and/or resolve profiles 90, 92.

In block 830 which follows, computer 18 may identify a wheel imbalance in one of wheels 28FL or 28RL by using the vehicle speed v and the vibration profiles 90, 92 to determine an absence of correlation (e.g., an absence of time correlation). Memory 52 of computer 18 also may store a wheelbase distance (s, see FIG. 3). For example, distance s may be a linear measurement between an axle of front wheels 28FL, 28FR and an axle of rear wheels 28RL, 28RR. Using the speed v of the vehicle determined in block 824, computer 18 may determine an expected time delay Δt_{EXP} between the front wheel 28FL rolling over the roadway disturbance and when rear wheel 28RL should roll over the same disturbance. For example, Δt_{EXP}=v/s. Then, using the vibration profiles 90, 92, computer 18 may determine an actual time delay or difference (Δt_{ACT}). In block 830, computer 18 may determine wheel imbalance or at least a high likelihood of imbalance when Δt_{EXP} does not equal Δt_{ACT} (or at least |Δt_{EXP}−Δt_{ACT}| is greater than a tolerance threshold). Stated differently, when the absolute value of the difference of these time deltas (|Δt_{EXP}−Δt_{ACT}|) is greater than the tolerance threshold, there is an absence of time correlation and a wheel imbalance has been determined. (Thereafter, in at least one example, block 810 may be used following block 820 to determine which of the two wheels 28FL, 28RL has the imbalance.)

Turning now to subroutine 840, computer 18 may determine a wheel imbalance at least partially based on a vibration profile that includes the vehicle 14 moving at different speeds. According to one non-limiting example of block 840, computer 18 may distinguish wheel imbalance from debris (such as a rock or other object) being lodged within a tread of a tire of a respective wheel. Subroutine 840 may comprise instructional blocks 842 and 844.

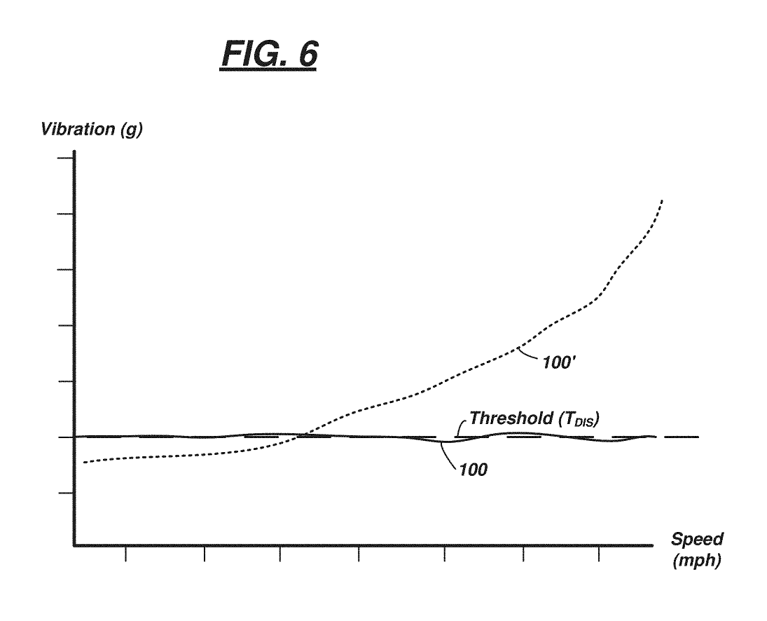

In block 842, computer 18 may generate a vibration profile for a wheel at a plurality of vehicle speeds. Thus, computer 18 may sample vibration magnitudes of a particular wheel (e.g., using sensors 36 and/or 38) while sampling corresponding wheel speeds (e.g., via one of sensors 34). This sampling again may include filtering the sensor data in accordance with the angular frequency of the respective wheel (e.g., as discussed already above). An illustrative sampling of this data is shown in FIG. 6. A vibration profile 100 for a left front wheel 28FL is shown, wherein a rock has become lodged in the tire tread. Notably, if a rock is embedded in the tire, the vibration magnitude may vary little at higher or lower speeds. Further, according to one example, the magnitude of profile 100 may approximate threshold (T_{DIS}). Computer 18 may avoid a false-positive determination (e.g., when the vibration magnitude greater than or equal to the threshold (T_{DIS})) by determining that the profile is insensitive to vehicle speed v. FIG. 6 illustrates an example of profile 100 being insensitive to vehicle speed.

FIG. 6 also illustrates another vibration profile 100′ (of wheel 28FL) which could be determined using sensor data associated with the same wheel, except that here, the profile indicates a wheel imbalance. For example, vibration profile 100′ is not insensitive to vehicle speed and is therefore indicative of a wheel imbalance. For example, in block 844, computer 18 may determine a wheel imbalance when it determines that vibration magnitude in the profile (100′) increases with increased vehicle speed v. Thus, in contradistinction to profile 100, profile 100′ is sensitive to vehicle speed v and therefore is indicative of wheel imbalance. Thus, computer 18, by executing subroutine 840, may distinguish debris captured within a tire tread from wheel imbalance.

Again, as discussed above, any of subroutines 810, 820, and/or 840 may be used in combination with one another to determine wheel imbalance. In at least one example, at least two subroutines 810, 820, 840 are used, as determining a wheel imbalance using one subroutine is verified by executing the other. Still further, in some examples, at least one subroutine determines an existence of wheel imbalance at vehicle 14, and another subroutine determines which wheel is imbalanced.

Returning to process 700, thus in block 730 computer 18 may determine an unbalanced wheel in vehicle 14. Following block 730, the process may proceed to block 740 when a wheel imbalance is determined. If no imbalance is determined, then process 700 may loop back and repeat block 710 (e.g., using different or more recent sensor data).

In block 740, computer 18 may execute a vehicle function based on a determination of block 730. According to one non-limiting example, computer 18 may command HMI module 60 to display a notification to passengers of the vehicle 14. According to some examples, the notification may instruct the passengers to obtain authorized vehicle service. According to another example, the computer 18 may instruct the vehicle 14 to navigate to a service center. Other vehicle functions are possible. Following block 740, the process ends.

Returning to block 730′, block 730′ may follow block 720—e.g., when the computer 18 determines to execute a portion of process 800 at server 12. Thus, according to one example, computer 18 may transmit a sensor data file to server 12 so that the server may determine (in block 730′) whether a wheel imbalance exists in vehicle 14. As discussed above, this block may include similar or identical instructions which—in other implementations—could be executed entirely by computer 18. As these instructions (e.g., process 800) could be identical at the server 12, these instructions will not be re-explained here. When server 12 determines an imbalance in block 730′, then process 700 may proceed to block 750. And when server 12 does not determine an imbalance in block 730′, then the process may proceed to block 760.

In block 750, the determination (of wheel imbalance, as well as which wheel is imbalanced) is transmitted to vehicle 14 and is received by computer 18 via telematics device 58. Following receipt, the process continues to block 730. In this instance, computer 18 determines wheel imbalance (and/or which wheel is unbalanced) based on the communication from server 12—and proceeds as previously described.

In block 760—when no wheel imbalance is determined by server 12, then process 700 loops back and repeats block 730′ (i.e., repeats block 730′ when server 12 receives additional sensor data from vehicle 14). It should be appreciated that blocks 730′, 750, 760 are optional; thus, in at least one example, all instructions are carried out by computer 18 onboard vehicle 14.

Processes 700 and/or 800 may include other instructions or subroutines. Further, at least some of these subroutines include using suspension system or other suitable data to determine the existence of wheel imbalance within vehicle 14 and/or which wheel is unbalanced.

In still other examples, the computer 18 and/or server 12 may compare historical vibration profile data with recently-received sensor data from sensors 34, 36, and/or 38. For example, computer 18 may determine wheel imbalance based on trend data of vehicle 14 (e.g., or by comparison to other similarly-suited vehicles).

Thus, there has been described a wheel imbalance sensing for a vehicle. The system includes a computer onboard the vehicle that using sensor data to determine wheel imbalance and/or isolate which wheel is unbalanced. Further, in one example, the system includes a remote server that executes instructions to assist in one or more of these determinations.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method, comprising:
at a vehicle computer:
determining a vehicle speed;
determining, for a first wheel, a first vibration profile;
determining, for a second wheel, a second vibration profile that includes a roadway disturbance input; and
using the speed and the two profiles, determining a wheel imbalance at the first wheel.

2. The method of claim 1, further comprising, at the computer: using a wheelbase distance to determine the imbalance.

3. The method of claim 2, wherein the first and second wheels are on a common side of a vehicle.

4. The method of claim 1, wherein determining the imbalance comprises determining an absence of correlation between a vibration magnitude in the first vibration profile and the input of the second vibration profile.

5. The method of claim 1, wherein determining the imbalance further comprises: determining a vibration profile for each of a plurality of wheels in the vehicle; and determining that the vibration magnitude of one profile is a threshold larger than vibration magnitudes associated with a remainder of the plurality.

6. The method of claim 1, wherein the first and second vibration profiles comprise acceleration data.

7. The method of claim 6, wherein the acceleration data is provided to the computer via one or more accelerometers located at each of the first and second wheels.

8. The method of claim 6, wherein the first and second vibration profiles further comprise rotational-rate data.

9. The method of claim 8, wherein the rotational-rate data is provided to the computer via one or more rotational-rate sensors which comprise one of an antilock brake system, an electronic stability control system, or a roll stability control system.

10. The method of claim 1, further comprising distinguishing debris captured within a tire tread from wheel imbalance.

11. A method, comprising:
for a vehicle:
determining, for a first wheel, a first vibration profile;
determining, for a second wheel, a second vibration profile that includes a roadway disturbance input;
attempting to correlate the first and second profiles; and
based on an absence of correlation, determining a wheel imbalance at the first wheel.

12. The method of claim 11, further comprising performing at least a portion of the wheel imbalance determination at a remote server.

13. A computer, comprising:
a processor and memory storing instructions executable by the processor, the instructions comprising, to:
determine a vehicle speed;
determine, for a first wheel, a first vibration profile;
determine, for a second wheel, a second vibration profile that includes a roadway disturbance input; and
using the speed and the two profiles, determine a wheel imbalance at the first wheel.

14. The computer of claim 13, wherein the instructions further comprise, to: use a wheelbase distance to determine the imbalance.

15. The computer of claim 13, wherein the first and second wheels are on a common side of a vehicle.

16. The computer of claim 13, wherein the instructions to determine the imbalance further comprise, to: determine an absence of correlation between a vibration magnitude in the first vibration profile and the input of the second vibration profile.

17. The computer of claim 13, wherein the instructions to determine the imbalance further comprise, to: determine a vibration profile for each of a plurality of wheels in the vehicle; and determine that the vibration magnitude of one profile is a threshold larger than vibration magnitudes associated with a remainder of the plurality.

18. The computer of claim 13, wherein the first and second vibration profiles comprise acceleration data.

19. The computer of claim 18, wherein the acceleration data is provided to the computer via one or more accelerometers located at each of the first and second wheels.

20. The computer of claim 19, wherein the first and second vibration profiles further comprise rotational-rate data.
